(19) United States
(12) Patent Application Publication
(10) Pub. No.: US 2026/0296027 A1
(43) Pub. Date: Oct. 1, 2026

(54) Cleaning Device

(71) Applicant: SEIKO EPSON CORPORATION, Tokyo (JP)

(72) Inventor: Mio SASAKI, Shiojiri (JP)

(21) Appl. No.: 19/629,231

(22) Filed: Mar. 26, 2026

(30) Foreign Application Priority Data
Mar. 27, 2025 (JP) 2025-053171

(51) Int. Cl. B41J 2/165

(52) U.S. Cl. CPC B41J 2/16517; B41J 2002/16567

(57) ABSTRACT

A cleaning device includes a liquid injection head having a nozzle plate and a head cleaner, the nozzle plate has an injection surface in which nozzle openings are formed, the head cleaner includes a cap that covers the injection surface, and an ultrasonic device provided in the cap, the ultrasonic device includes a first element group in which a plurality of first ultrasonic elements having a first frequency as a resonance frequency and transmitting a first ultrasonic wave having the first frequency are arranged, and a second element group in which a plurality of second ultrasonic elements having a second frequency lower than the first frequency as a resonance frequency and transmitting a second ultrasonic wave having the second frequency are arranged, and the first element group and the second element group are alternately disposed along a second direction parallel to the injection surface.

The present application is based on, and claims priority from JP Application Serial Number 2025-053171, filed Mar. 27, 2025, the disclosure of which is hereby incorporated by reference herein in its entirety.

### BACKGROUND

### 1. Technical Field

The present disclosure relates to a cleaning device.

### 2. Related Art

JP-A-2006-347000 discloses a droplet ejection apparatus in which an ultrasonic vibrator is attached to a cap put on an ejection head in order to prevent evaporation of an ejection liquid. In this apparatus, in the state where the ejection nozzle and the cap are filled with a liquid, the ejection nozzle is covered by the cap, and an ultrasonic wave is oscillated from the ultrasonic vibrator to clean the ejection nozzle and the nozzle plate.

JP-A-2006-347000 is an example of the related art.

When the foreign matter adhering to the nozzle is removed using an ultrasonic wave, the frequency of the ultrasonic wave appropriate for removing the foreign matter varies depending on the size, type, and the like of the foreign matter. Therefore, with an ultrasonic device having a single resonance frequency, it may be difficult to efficiently remove the foreign matter adhering to the nozzle.

### SUMMARY

According to a first aspect of the present disclosure, a cleaning device is provided. The cleaning device includes a liquid injection head, and a head cleaner disposed below the liquid injection head, wherein the liquid injection head includes a piezoelectric element, a diaphragm that vibrates by driving of the piezoelectric element, a pressure chamber that applies pressure to a liquid stored therein by vibration of the diaphragm, and a nozzle plate having at least one nozzle row in which nozzles communicating with the pressure chamber and injecting the liquid are arranged along a first direction, the nozzle plate has an injection surface in which nozzle openings of the nozzles are formed on a lower surface of the nozzle plate, the head cleaner includes a cap that is disposed to face the injection surface and covers the injection surface, and an ultrasonic device that is provided in the cap and transmits an ultrasonic wave to a liquid filled in the cap, the ultrasonic device includes a first element group in which a plurality of first ultrasonic elements having a first frequency as a resonance frequency and transmitting a first ultrasonic wave having the first frequency are arranged, and a second element group in which a plurality of second ultrasonic elements having a second frequency lower than the first frequency as a resonance frequency and transmitting a second ultrasonic wave having the second frequency are arranged, and the first element group and the second element group are alternately arranged along a second direction parallel to the injection surface.

### BRIEF DESCRIPTION OF THE DRAWINGS

FIG. 1 shows a schematic configuration of a liquid injection apparatus.

FIG. 2 is an exploded perspective view showing a configuration of a liquid injection head.

FIG. 3 shows the configuration of the liquid injection head in plan view.

FIG. 4 is a cross-sectional view taken along line IV-IV in FIG. 3.

FIG. 5 is a cross-sectional view schematically showing a detailed configuration of a piezoelectric element.

FIG. 6 shows a schematic configuration of a head cleaner.

FIG. 7 is a partial cross-sectional view of the liquid injection head and the head cleaner.

FIG. 8 is a top view of an ultrasonic device.

FIG. 9 is a plan view showing a schematic configuration of a first element group.

FIG. 10 is a cross-sectional view taken along line X-X in FIG. 9.

FIG. 11 is a cross-sectional view taken along line XI-XI in FIG. 9.

FIG. 12 is a flowchart showing a method cleaning nozzles.

FIG. 13 is a partial cross-sectional view of a liquid injection head and a head cleaner according to a second embodiment.

FIG. 14 is a top view of an ultrasonic device in the second embodiment.

FIG. 15 is a partial cross-sectional view of a liquid injection head and a head cleaner according to a third embodiment.

FIG. 16 is a top view of an ultrasonic device in the third embodiment.

FIG. 17 is a partial cross-sectional view of a liquid injection head and a head cleaner according to a fourth embodiment.

FIG. 18 is a top view of an ultrasonic device in the fourth embodiment.

FIG. 19 shows relationships between conditions of a nozzle and waveforms of reflected waves.

FIG. 20 is a flowchart showing a method cleaning nozzles in the fourth embodiment.

FIG. 21 is a flowchart of cleaning processing.

FIG. 22 is a partial cross-sectional view of a liquid injection head and a head cleaner according to a fifth embodiment.

FIG. 23 is a top view of an ultrasonic device in the fifth embodiment.

### DESCRIPTION OF EMBODIMENTS

### A. First Embodiment:

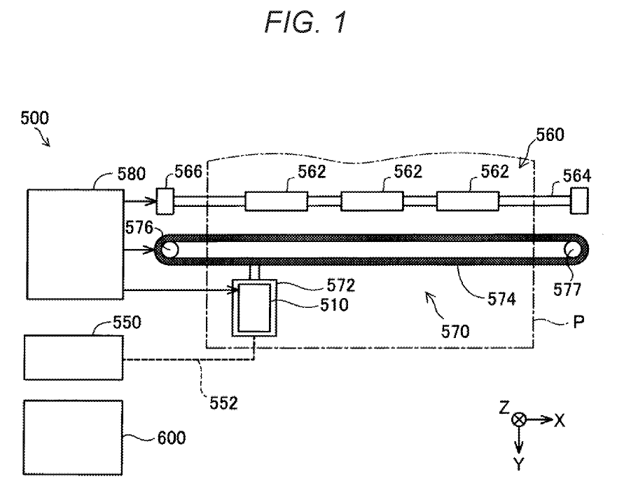

FIG. 1 shows a schematic configuration of a liquid injection apparatus 500. In the present embodiment, the liquid injection apparatus 500 is an inkjet printer that ejects ink, which is an example of a liquid, onto printing paper P to form an image. In the liquid injection apparatus 500, instead of the printing paper P, any type of medium such as a resin film or fabric may be used as an object to which the ink is injected. In FIG. 1, arrows indicating X, Y, and Z directions orthogonal to one another are illustrated. The X directions and the Y directions are parallel to a horizontal plane. The Z direction is parallel to a vertical direction. The X, Y, and Z directions in FIG. 1 and the X, Y, and Z directions in the other drawings indicate the same directions. To specify a direction, a positive or negative sign is added to the description of the direction, where "+" refers to a positive direction that is a direction indicated by an arrow, and "-" refers to a negative direction that is an opposite direction to the direction indicated by the arrow. In the present specification, the +Z direction indicates a vertically downward direction, and the -Z direction indicates a vertically upward direction.

The liquid injection apparatus 500 includes a liquid injection head 510, an ink tank 550, a conveying mechanism 560, a moving mechanism 570, a head cleaner 600, and a controller 580. A plurality of nozzles are formed in the liquid injection head 510, and for example, ink of a total of four colors of black, cyan, magenta, and yellow is injected in the +Z direction to form an image on the printing paper P. The liquid injection head 510 is mounted on a carriage 572 and reciprocates in the main scanning directions with the movement of the carriage 572. In the present embodiment, the main scanning directions are the +X direction and the -X direction.

The ink tank 550 stores ink to be injected by the liquid injection head 510. The ink tank 550 is coupled to the liquid injection head 510 by a tube 552 made of resin. The ink in the ink tank 550 is supplied to the liquid injection head 510 via the tube 552. Instead of the ink tank 550, a bag-shaped liquid pack formed of a flexible film may be provided.

The conveying mechanism 560 conveys the printing paper P in sub-scanning directions. The sub-scanning directions are directions intersecting to the X directions as the main scanning directions, and the +Y direction and the -Y direction in the present embodiment. The conveying mechanism 560 includes a conveying rod 564 to which three conveying rollers 562 are attached, and a conveying motor 566 that rotationally drives the conveying rod 564. When the conveying motor 566 rotationally drives the conveying rod 564, the printing paper P is conveyed in the +Y direction as the sub-scanning direction. Any number of conveying rollers 562 may be used, not limited to three.

The moving mechanism 570 includes the carriage 572, a conveying belt 574, a moving motor 576, and a pulley 577. On the carriage 572, the liquid injection head 510 in a state capable of injecting ink is mounted. The carriage 572 is fixed to the conveying belt 574. The conveying belt 574 is stretched between the moving motor 576 and the pulley 577. When rotationally driven by the moving motor 576, the conveying belt 574 reciprocates in the main scanning directions. Accordingly, the carriage 572 fixed to the conveying belt 574 also reciprocates in the main scanning directions.

The head cleaner 600 cleans the nozzles of the liquid injection head 510. The details of the controller 600 will be described later. In the present disclosure, the head cleaner 600 and the liquid injection head 510 are also collectively referred to as a cleaning device.

The controller 580 is configured as a microcomputer including a CPU and a storage unit. The storage unit is, for example, a non-volatile memory erasable by an electric signal such as an EEPROM, a non-volatile memory erasable by ultraviolet rays such as a One-Time-PROM or an EPROM, or an inerasable non-volatile memory such as an PROM. The storage unit stores various programs for implementing the functions provided in the present embodiment. The CPU comprehensively controls each unit of the liquid injection apparatus 500 by loading and executing the programs stored in the storage unit. The controller 580 controls the reciprocating operation of the carriage 572 along the main scanning directions, the conveying operation of the printing paper P along the sub-scanning directions, the injection operation of injecting the liquid from the liquid injection head 510, and the like.

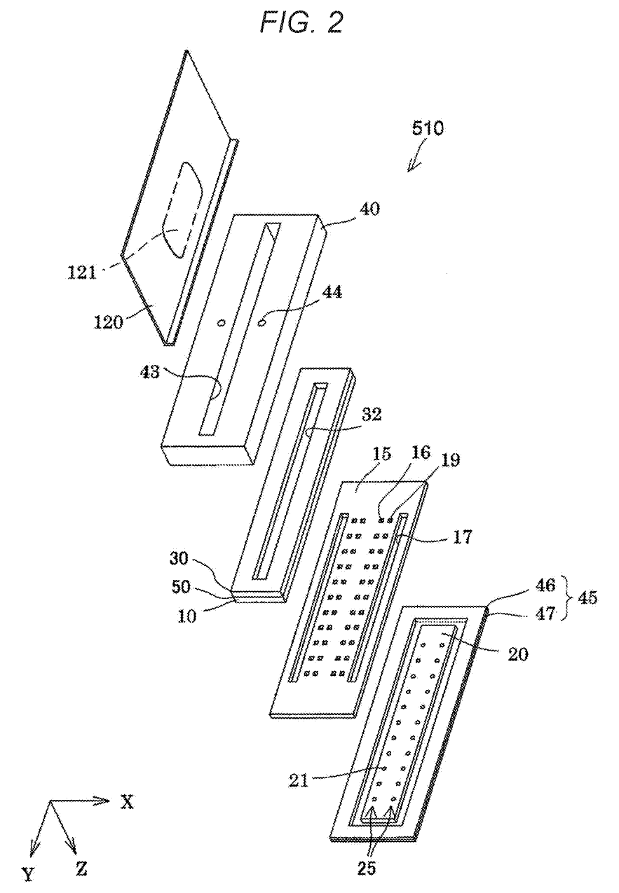

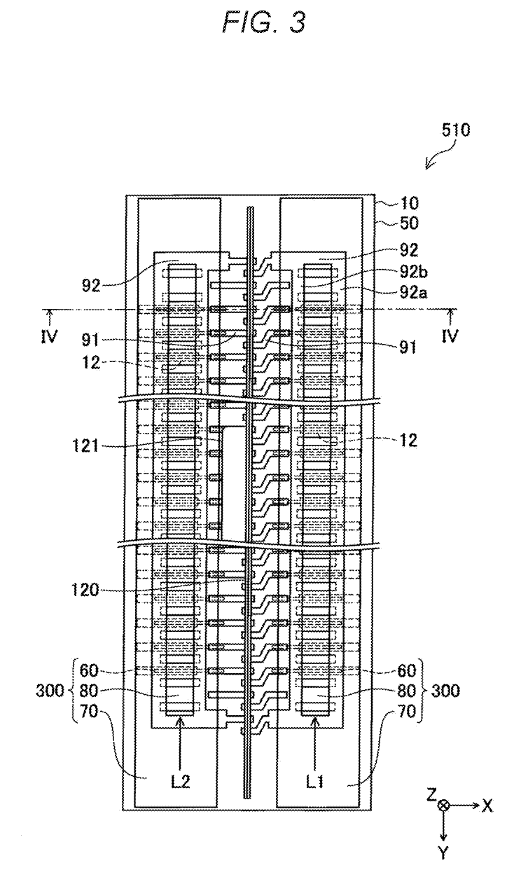

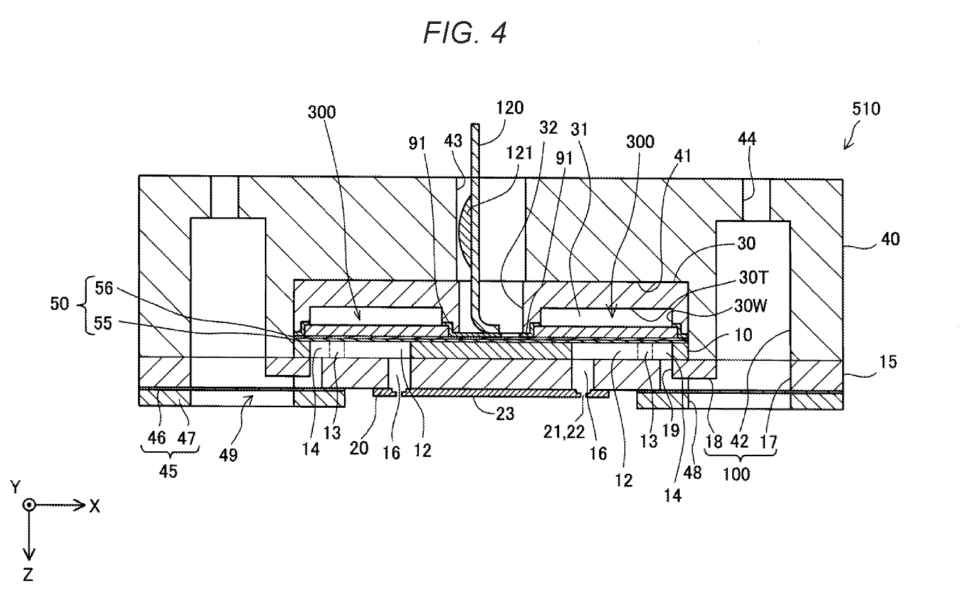

A detailed configuration of the liquid injection head 510 will be described with reference to FIGS. 2 to 4. FIG. 2 is an exploded perspective view showing the configuration of the liquid injection head 510. FIG. 3 shows the configuration of the liquid injection head 510 in plan view. In the present disclosure, "in plan view" refers to an object viewed along the vertical direction. FIG. 3 illustrates the configuration around a pressure chamber substrate 10 and a diaphragm 50 in the liquid injection head 510, and in order to facilitate understanding of the technology, a protective film 82, a sealing substrate 30, a case member 40, and the like are not illustrated. FIG. 4 is a cross-sectional view taken along line IV-IV in FIG. 3.

The liquid injection head 510 includes the pressure chamber substrate 10, a communication plate 15, a nozzle plate 20, a compliance substrate 45, the diaphragm 50, the sealing substrate 30, the case member 40, and a wiring board 120 illustrated in FIG. 2, and piezoelectric elements 300 illustrated in FIG. 3. The liquid injection head 510 is formed by laminating these laminated members. In the present disclosure, the direction in which the laminated members forming the liquid injection head 510 are laminated is also referred to as a "lamination direction". In the present embodiment, the lamination direction coincides with the Z directions.

The pressure chamber substrate 10 is formed using, for example, a silicon substrate, a glass substrate, an SOI substrate, or various ceramic substrates. As illustrated in FIG. 3, a plurality of pressure chambers 12 are provided in the pressure chamber substrate 10. The pressure chamber 12 is provided to extend along the X direction. Specifically, the pressure chamber 12 is formed in a substantially rectangular shape having a length in the X direction longer than a length in the Y direction in plan view. The shape of the pressure chamber 12 is not limited to the rectangular shape, and may be a parallelogram shape, a polygonal shape, or the like. In the present specification, the X direction is also referred to as an "extension direction".

As illustrated in FIG. 3, the plurality of pressure chambers 12 are arranged along a direction intersecting the extension direction in the pressure chamber substrate 10. In the present specification, the direction in which the plurality of pressure chambers 12 are arranged in plan view is also referred to as an "arrangement direction". In the present embodiment, the plurality of pressure chambers 12 are arranged in two rows parallel to each other with the Y direction as the arrangement direction. In the example of FIG. 3, two pressure chamber rows of a first pressure chamber row L1 having a first arrangement direction parallel to the Y direction and a second pressure chamber row L2 having a second arrangement direction parallel to the Y direction are formed in the pressure chamber substrate 10.

As shown in FIG. 2, the communication plate 15, the nozzle plate 20, and the compliance substrate 45 are laminated at the +Z direction side of the pressure chamber substrate 10. The communication plate 15 is a flat plate-shaped member using, for example, a silicon substrate, a glass substrate, an SOI substrate, various ceramic substrates, or a metal substrate. The communication plate 15 is provided with nozzle communication paths 16, and first manifold portions 17, second manifold portions 18 illustrated in FIG. 4, and supply communication paths 19.

As illustrated in FIG. 4, the nozzle communication path 16 is a flow path through which the pressure chamber 12 communicates with a nozzle 21. The first manifold portion 17 and the second manifold portion 18 function as a part of a manifold 100 serving as a common liquid chamber with which the plurality of pressure chambers 12 communicate. The first manifold portion 17 is provided so as to penetrate the communication plate 15 in the Z direction. As illustrated in FIG. 4, the second manifold portion 18 is provided on the surface of the communication plate 15 at the +Z direction side without penetrating the communication plate 15 in the Z direction.

As illustrated in FIG. 4, the supply communication path 19 is a flow path coupled to a pressure chamber supply path 14 provided in the pressure chamber substrate 10. The pressure chamber supply path 14 is a flow path coupled to one end portion of the pressure chamber 12 in the X direction via a throttle portion 13. The throttle portion 13 is a flow path provided between the pressure chamber 12 and the pressure chamber supply path 14. The throttle portion 13 is a flow path whose inner wall protrudes more than the pressure chamber 12 and the pressure chamber supply path 14 and is formed to be narrower than the pressure chamber 12 and the pressure chamber supply path 14. Accordingly, the throttle portion 13 has a higher flow path resistance than the pressure chamber 12 and the pressure chamber supply path 14. According to the configuration, even when pressure is applied to the pressure chamber 12 by the piezoelectric element 300 at the time of injection of ink, it is possible to suppress or prevent the ink within the pressure chamber 12 from flowing back to the pressure chamber supply path 14. A plurality of the supply communication paths 19 are arranged along the Y direction, that is, the arrangement direction, and are individually provided for each of the pressure chambers 12. The supply communication path 19 and the pressure chamber supply path 14 cause the second manifold portion 18 to communicate with each pressure chamber 12 and supply the ink within the manifold 100 to each pressure chamber 12.

The nozzle plate 20 is provided at the side opposite to the pressure chamber substrate 10 with the communication plate 15 in between, that is, on the surface of the communication plate 15 at the +Z direction side. The material of the nozzle plate 20 is not particularly limited. For example, a silicon substrate, a glass substrate, an SOI substrate, various ceramic substrates, or a metal substrate can be used. Examples of the metal substrate include a stainless steel substrate. As the material of the nozzle plate 20, an organic material such as polyimide resin can also be used.

A plurality of the nozzles 21 are formed in the nozzle plate 20. Each nozzle 21 communicates with each pressure chamber 12 via the nozzle communication path 16. As illustrated in FIG. 2, the plurality of nozzles 21 are arranged along the arrangement direction of the pressure chambers 12, that is, the Y direction. In the present disclosure, the direction in which the plurality of nozzles 21 are arranged is also referred to as a "first direction". In the present embodiment, the first direction is the Y direction. That is, the nozzles 21 are arranged along the first direction. The nozzle plate 20 is provided with two nozzle rows 25 in which the plurality of nozzles 21 are arranged along the first direction. The two nozzle rows 25 respectively correspond to the first pressure chamber row L1 and the second pressure chamber row L2. As shown in FIG. 4, the nozzle plate 20 has an injection surface 23 in which nozzle openings 22 of the nozzles 21 are formed. The injection surface 23 is a lower surface of the nozzle plate 20, that is, a surface of the nozzle plate 20 at the +Z direction side.

As illustrated in FIG. 4, the compliance substrate 45 is provided together with the nozzle plate 20 at the side opposite to the pressure chamber substrate 10 with the communication plate 15 in between, that is, on the surface of the communication plate 15 at the +Z direction side. The compliance substrate 45 is provided around the nozzle plate 20, and covers the openings of the first manifold portions 17 and the second manifold portions 18 provided in the communication plate 15. The compliance substrate 45 includes, for example, a sealing film 46 formed of a thin film having flexibility and a fixing substrate 47 formed of a hard material such as metal. As illustrated in FIG. 4, a region of the fixing substrate 47 facing the manifold 100 is completely removed in the thickness direction to define an opening 48. Therefore, one surface of the manifold 100 is a compliance portion 49 sealed only by the sealing film 46.

As illustrated in FIG. 4, the diaphragm 50 and the piezoelectric element 300 are laminated at the opposite side to the communication plate 15 and the like with the pressure chamber substrate 10 in between, that is, the surface of the pressure chamber substrate 10 at the -Z direction side. The piezoelectric element 300 flexurally deforms the diaphragm 50 to cause a pressure change in the ink within the pressure chamber 12. In FIG. 4, the illustration of the piezoelectric element 300 is simplified.

The diaphragm 50 is provided between the piezoelectric element 300 and the pressure chamber substrate 10. The diaphragm 50 includes an elastic film 55 provided at a position closer to the pressure chamber substrate 10 side than the piezoelectric element 300 and having silicon oxide (SiO₂), and an insulator film 56 provided on the elastic film 55 and having a zirconium oxide film (ZrO₂). The elastic film 55 forms a surface at the -Z direction side of the flow path including the pressure chamber 12. The diaphragm 50 may include, for example, one of the elastic film 55 and the insulator film 56, and may further include a film other than the elastic film 55 and the insulator film 56. Examples of the material of the other film include silicon and silicon nitride.

As illustrated in FIG. 2, the sealing substrate 30 having substantially the same size as the pressure chamber substrate 10 in plan view is further bonded to the surface of the pressure chamber substrate 10 at the -Z direction side by an adhesive or the like. As shown in FIG. 4, the sealing substrate 30 includes a ceiling portion 30T, a wall portion 30W, a holding portion 31, and a through hole 32. The holding portion 31 is a space defined by the ceiling portion 30T and the wall portion 30W, and protects the active portion of the piezoelectric element 300 by housing the piezoelectric element 300. In the present embodiment, the holding portion 31 is provided for each row of the piezoelectric elements 300, and more specifically, two holding portions 31 corresponding to the first pressure chamber row L1 and the second pressure chamber row L2 are formed adjacent to each other. The through hole 32 penetrates the sealing substrate 30 along the Z direction. The through hole 32 is disposed between the two holding portions 31 in plan view, and is formed in an elongated rectangular shape along the Y direction.

As illustrated in FIG. 4, the case member 40 is fixed on the sealing substrate 30. The case member 40 forms the manifold 100 communicating with the plurality of pressure chambers 12 together with the communication plate 15. The case member 40 has substantially the same outer shape as the communication plate 15 in plan view, and is bonded so as to cover the sealing substrate 30 and the communication plate 15.

The case member 40 includes a housing portion 41, supply ports 44, third manifold portions 42, and a coupling port 43. The housing portion 41 is a space having a depth capable of housing the pressure chamber substrate 10, the diaphragm 50, and the sealing substrate 30. The third manifold portions 42 are spaces formed near both ends of the housing portion 41 in the X direction in the case member 40. The manifold 100 is formed by coupling the third manifold portion 42 to the first manifold portion 17 and the second manifold portion 18 provided in the communication plate 15. The manifold 100 has a shape elongated in the Y direction. The supply port 44 communicates with the manifold 100 and supplies ink to each manifold 100. The coupling port 43 is a through hole communicating with the through hole 32 of the sealing substrate 30, and the wiring board 120 is inserted therethrough.

The liquid injection head 510 takes in the ink supplied from the ink tank 550 illustrated in FIG. 1 from the supply ports 44 illustrated in FIG. 4, fills the internal flow paths from the manifolds 100 to the nozzles 21 with the ink, and then applies a voltage based on a drive signal to each of the piezoelectric elements 300 corresponding to the plurality of pressure chambers 12. Accordingly, the diaphragm 50 is deflected together with the piezoelectric elements 300, the volume of each pressure chamber 12 is changed, the internal pressure is increased, and ink droplets are ejected from each nozzle 21.

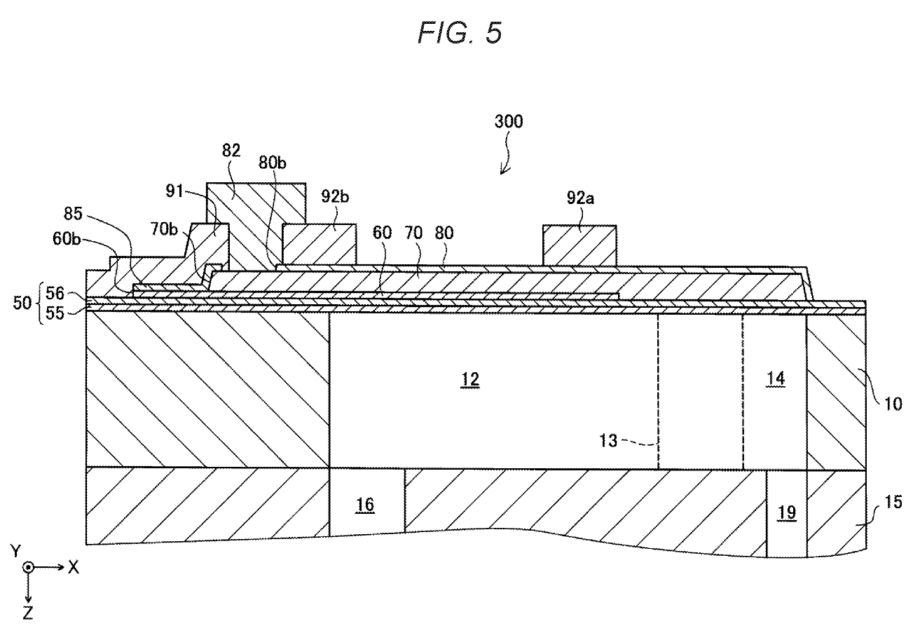

The configuration of the piezoelectric element 300 will be described with reference to FIGS. 3 and 4 and 5 as appropriate. FIG. 5 is a cross-sectional view schematically showing a detailed configuration of the piezoelectric element 300. As illustrated in FIG. 5, the piezoelectric element 300 includes a first electrode 60, a piezoelectric material 70, and a second electrode 80. The first electrode 60, the piezoelectric material 70, and the second electrode 80 are laminated in this order in the -Z direction of the lamination direction. The piezoelectric material 70 is provided between the first electrode 60 and the second electrode 80 in the lamination direction.

The first electrode 60 and the second electrode 80 are electrically coupled to the wiring board 120 illustrated in FIGS. 3 and 4 via drive wiring. The drive wiring includes a first drive wire 91 that electrically couples the wiring board 120 and the first electrode 60, and a second drive wire 92 that electrically couples the wiring board 120 and the second electrode 80. The first electrode 60 and the second electrode 80 apply a voltage corresponding to the drive signal to the piezoelectric material 70. The drive voltage is a voltage applied to the piezoelectric element 300 from the first electrode 60 and the second electrode 80 by the controller 580 to drive the piezoelectric element 300. In the piezoelectric element 300, a portion in which piezoelectric distortion occurs in the piezoelectric material 70 when a voltage is applied between the first electrode 60 and the second electrode 80 is also referred to as an active portion, and a portion in which piezoelectric distortion does not occur in the piezoelectric material 70 is also referred to as an inactive portion.

A different drive voltage is applied to the first electrode 60 according to the injection amount of ink, and a predetermined reference voltage is applied to the second electrode 80 regardless of the amount of ink injection. When a voltage difference is generated between the first electrode 60 and the second electrode 80 by applying the drive voltage and the reference voltage, the piezoelectric material 70 of the piezoelectric element 300 is deformed. Due to the deformation of the piezoelectric material 70, the diaphragm 50 deforms or vibrates, and the volume of the pressure chamber 12 changes. By changing the volume of the pressure chamber 12, pressure is applied to the ink stored in the pressure chamber 12, and the ink is injected from the nozzle 21 via the nozzle communication path 16.

The first electrode 60 is an individual electrode individually provided for the plurality of pressure chambers 12. As illustrated in FIG. 5, the first electrode 60 is a lower electrode provided at the opposite side to the second electrode 80 with the piezoelectric material 70 in between, that is, at the downside of the piezoelectric material 70. The first electrode 60 is formed of, for example, a conductive material including a metal such as platinum (Pt), iridium (Ir), gold (Au), or titanium (Ti), or a conductive metal oxide such as indium tin oxide abbreviated as ITO. Alternatively, the first electrode 60 may be formed by lamination of a plurality of materials including platinum (Pt), iridium (Ir), gold (Au), and titanium (Ti).

As illustrated in FIG. 3, the piezoelectric material 70 has a predetermined width in the X direction and has an elongated rectangular shape along the arrangement direction of the pressure chambers 12, that is, the Y direction. Examples of the piezoelectric material 70 include a crystal film having a perovskite structure, that is, a so-called perovskite crystal formed of a ferroelectric ceramic material exhibiting an electromechanical conversion effect formed on the first electrode 60. As the material of the piezoelectric material 70, for example, a ferroelectric piezoelectric material such as lead zirconate titanate (PZT) or a material obtained by adding a metal oxide such as niobium oxide, nickel oxide, or magnesium oxide to the ferroelectric piezoelectric material can be used. Specifically, lead titanate (PbTiO₃), lead zirconate titanate (Pb(Zr,Ti)O₃), lead zirconate titanate (PbZrO₃), lead lanthanum titanate ((Pb,La),TiO₃), lead lanthanum zirconate titanate (Pb,La)(Zr,Ti)O₃), lead magnesium niobate zirconium titanate (Pb(Zr,Ti)(Mg,Nb)O₃), or the like can be used.

The material of the piezoelectric material 70 is not limited to a lead-based piezoelectric material containing lead, but a lead-free piezoelectric material containing no lead may be used. Examples of the lead-free piezoelectric material include bismuth ferrate ((BiFeO₃), abbreviated as "BFO"), barium titanate ((BaTiO₃), abbreviated as "BT"), lithium potassium sodium niobate ((K,Na,Li)(NbO₃)), lithium potassium niobate tantalate ((K,Na,Li)(Nb,Ta)O₃), bismuth potassium titanate ((Bi₁/2K_{1/2})TiO₃, abbreviated as "BKT"), bismuth sodium titanate ((Bi₁/2Na_{1/2})TiO₃, abbreviated as "BNT"), bismuth manganate (BiMnO₃, abbreviated as "BM"), a composite oxide having a perovskite structure containing bismuth, potassium, titanium, and iron (x[(BiₓK₁₋ₓ₎TiO₃]-(1-x)[BiFeO₃), abbreviated as "BKT-BF", a composite oxide having a perovskite structure containing bismuth, iron, barium, and titanium ((1-x)[BiFeO₃]-x[BaTiO₃], abbreviated as "BFO-BT"], and a material obtained by adding a metal such as manganese, cobalt, and chromium thereto ((1-x)[Bi(Fe_{1-y}M_{y})O₃]-x[BaTiO₃] (M is Mn, Co, or Cr).

As illustrated in FIG. 3, the second electrode 80 is a common electrode provided in common for the plurality of pressure chambers 12. The second electrode 80 has a predetermined width in the X direction and is provided to extend along the arrangement direction of the pressure chambers 12, that is, the Y direction. As illustrated in FIG. 5, the second electrode 80 is an upper electrode provided at the opposite side to the first electrode 60 with the piezoelectric material 70 in between, that is, at the upside of the piezoelectric material 70. The second electrode 80 is formed of, for example, a conductive material including a metal such as platinum (Pt), iridium (Ir), gold (Au), or titanium (Ti), or a conductive metal oxide such as indium tin oxide abbreviated as ITO. Alternatively, the second electrode 80 may be formed by lamination of a plurality of materials including platinum (Pt), iridium (Ir), gold (Au), and titanium (Ti).

As illustrated in FIG. 5, the protective film 82 is formed on an end portion of the second electrode 80 at the -X direction side. A material having electrical insulation properties and moisture barrier properties is used as the material of the protective film 82. As the protective film 82, for example, an oxide insulating film of aluminum oxide or hafnium oxide, a polymer material film of polyimide, or the like can be adopted. The protective film 82 is formed so as to cover one end portion 80b of the second electrode 80 and the surface of the piezoelectric material 70.

As illustrated in FIG. 5, a wiring portion 85 is provided further at the -X direction side than the end portion of the second electrode 80 in the -X direction. In FIG. 3, the illustration of the wiring portion 85 is omitted. The wiring portion 85 is in the same layer as the second electrode 80, but is electrically discontinuous with the second electrode 80. The wiring portion 85 is formed from one end portion 70b of the piezoelectric material 70 in the -X direction to one end portion 60b of the first electrode 60 in the -X direction apart from the one end portion 80b of the second electrode 80. The one end portion 60b of the first electrode 60 in the -X direction is drawn to the outer side than the one end portion 70b of the piezoelectric material 70. The wiring portion 85 is provided for each piezoelectric element 300, and a plurality of the wiring portions 85 are disposed at predetermined intervals along the Y direction. The wiring portion 85 may be formed in a layer different from that of the second electrode 80.

As shown in FIG. 5, the first drive wire 91 is electrically coupled to the first electrode 60 as the individual electrode, and an extension portion 92a and an extension portion 92b of the second drive wire 92 are electrically coupled to the second electrode 80 as the common electrode. The first drive wire 91 and the second drive wire 92 function as drive wires for applying a voltage for driving the piezoelectric material 70 from the wiring board 120.

The first drive wire 91 is individually provided for each first electrode 60. As illustrated in FIG. 5, the first drive wire 91 is coupled to the vicinity of the one end portion 60b of the first electrode 60 via the wiring portion 85, and is drawn out in the -X direction to the diaphragm 50. The first drive wire 91 is electrically coupled to one end portion 60b in the -X direction of the first electrode 60 drawn to the outer side than the one end portion 70b of the piezoelectric material 70. The wiring portion 85 may be omitted, and the first drive wire 91 may be directly coupled to the one end portion 60b of the first electrode 60.

As illustrated in FIG. 3, the second drive wire 92 extends along the Y direction, is bent at both ends in the Y direction, and is drawn out along the X direction. The second drive wire 92 has the extension portion 92a and the extension portion 92b extending along the Y direction. As illustrated in FIGS. 3 and 4, the end portions of the first drive wire 91 and the second drive wire 92 extend so as to be exposed to the through hole 32 of the sealing substrate 30, and are electrically coupled to the wiring board 120 in the through hole 32.

The first drive wire 91 and the second drive wire 92 are formed in the same layer in a state of being electrically discontinuous to each other. The first drive wire 91 and the second drive wire 92 may be formed in different layers from each other. The material of the first drive wire 91 and the second drive wire 92 is a material having conductivity, and for example, gold (Au), copper (Cu), titanium (Ti), tungsten (W), nickel (Ni), chromium (Cr), platinum (Pt), aluminum (Al), or the like can be used.

The wiring board 120 includes, for example, a flexible printed circuit (FPC). The wiring board 120 is formed with a plurality of wires for coupling to the controller 580 and a power supply circuit (not illustrated). Instead of the FPC, any flexible substrate such as an FFC (flexible flat cable) may be used. An integrated circuit 121 including a switching element and the like is mounted on the wiring board 120. A command signal for driving the piezoelectric element 300 and the like are input to the integrated circuit 121. The integrated circuit 121 controls the timing of supplying the drive signal for driving the piezoelectric element 300 to the first electrode 60 based on the command signal.

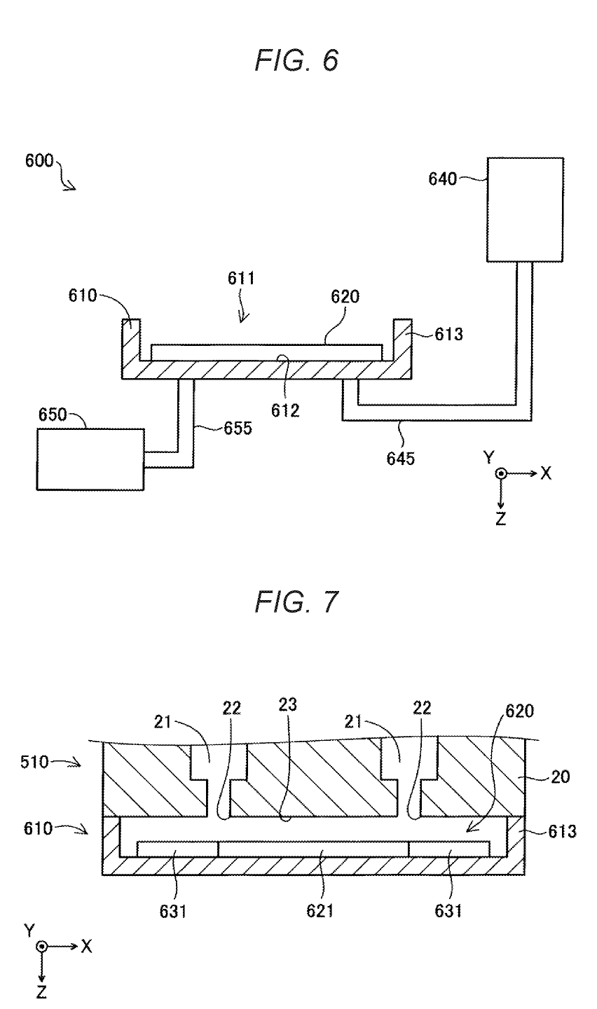

FIG. 6 shows a schematic configuration of the head cleaner 600. The head cleaner 600 includes a cap 610, an ultrasonic device 620, a cleaning liquid supply device 640, and a suction device 650. The cap 610 is provided to be attachable to the liquid injection head 510, and is attached to the liquid injection head 510 when the nozzles 21 are cleaned.

FIG. 7 is a partial cross-sectional view of the liquid injection head 510 and the head cleaner 600 in a state where the cap 610 is attached to the liquid injection head 510. FIG. 7 shows the cross-sectional view of a part of the nozzle plate 20 and the head cleaner 600 taken along a plane including the nozzles 21 and orthogonal to the Y direction as the first direction. As illustrated in FIG. 7, the cap 610 is located under the liquid injection head 510 when attached the liquid injection head 510. The cap 610 is disposed to face the injection surface 23 of the nozzle plate 20, and covers the injection surface 23 when attached to the liquid injection head 510. Specifically, the cap 610 covers all the nozzles 21 when attached to the liquid injection head 510. The cap 610 is formed of, for example, metal such as stainless steel or plastic resin.

As shown in FIG. 6, the cap 610 has a recess 611 capable of storing a liquid. The recess 611 includes an inner surface 612 facing the injection surface 23 and a side wall 613 protruding upward from the inner surface 612. The inner surface 612 is a surface of the cap 610 at the -Z direction side. In the present embodiment, the inner surface 612 is a flat surface parallel to the horizontal plane. The inner surface 612 may be a curved surface. The side wall 613 is provided on the outer circumferential portion of the cap 610, and comes into contact with the injection surface 23 in the state where the cap 610 is attached to the liquid injection head 510. Since the side wall 613 comes into contact with the injection surface 23, the liquid supplied to the recess 611 is prevented from leaking to the outside of the cap 610 during the cleaning of the nozzles 21. The side wall 613 is preferably formed of an elastic material. A packing made of an elastic material may be disposed at the upper end of the side wall 613. The ultrasonic device 620 is provided on the inner surface 612 of the cap 610. The details of the ultrasonic device 620 will be described later.

The cleaning liquid supply device 640 supplies a cleaning liquid to the recess 611 of the cap 610. As the cleaning liquid, for example, a solvent suitable for dissolving the foreign matter adhering to the nozzle 21, the ink itself, a main solvent of the ink, or the like can be used. The cleaning liquid supply device 640 is coupled to the cap 610 via a coupling pipe 645. The coupling pipe 645 is, for example, a hose having flexibility. The cleaning liquid supply device 640 supplies the cleaning liquid from the bottom of the cap 610 by pressure due to a difference in water level. The cleaning liquid supply device 640 may supply the cleaning liquid to the recess 611 from the opening of the cap 610, or may supply the cleaning liquid to the recess 611 using a pump or the like.

The suction device 650 suctions the liquid within the recess 611 of the cap 610. The suction device 650 is coupled to the cap 610 via a coupling pipe 655. The coupling pipe 655 is, for example, a hose having flexibility. The suction device 650 includes a suction pump (not illustrated) and collects the cleaning liquid via the coupling pipe 655. The suction device 650 is preferably capable of applying sufficient negative pressure to the recess 611 of the cap 610 and inside of the nozzles 21.

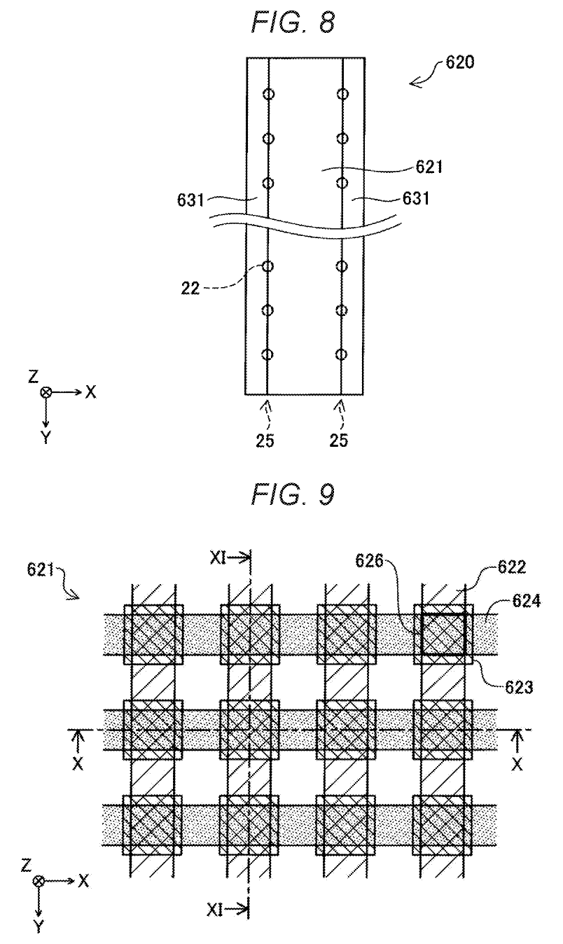

FIG. 8 is a top view of the ultrasonic device 620. In FIG. 8, the position of the nozzle opening 22 when the cap 610 is attached to the liquid injection head 510 is indicated by a broken line. The ultrasonic device 620 is provided in the cap 610 and transmits an ultrasonic wave to the liquid filled in the cap 610. As shown in FIGS. 7 and 8, the ultrasonic device 620 includes a first element group 621 and second element groups 631. The first element group 621 is an element group in which a plurality of first ultrasonic elements 626 whose resonance frequency is a first frequency are arranged. The second element group 631 is an element group in which a plurality of second ultrasonic elements whose resonance frequency is a second frequency lower than the first frequency are arranged.

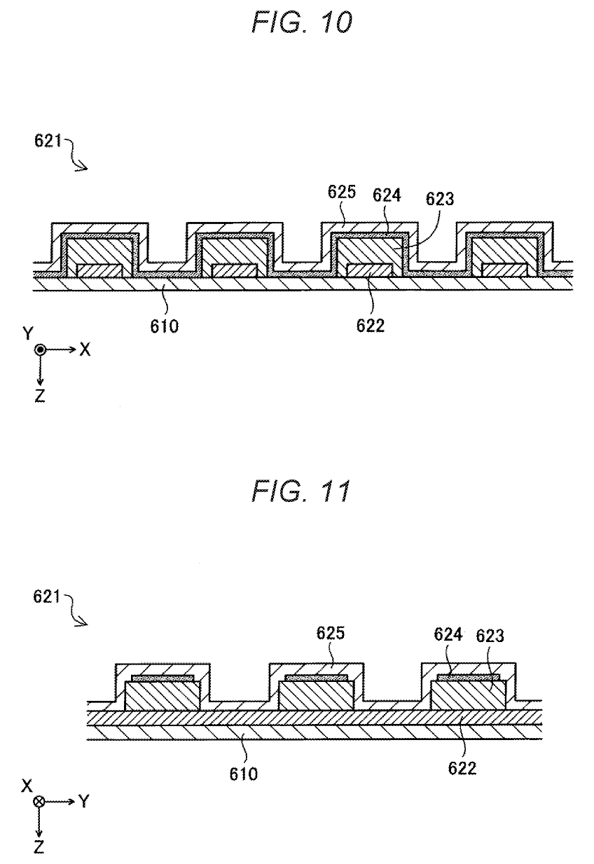

FIG. 9 is a plan view showing a schematic configuration of the first element group 621. FIG. 10 is a cross-sectional view taken along line X-X in FIG. 9. FIG. 11 is a cross-sectional view taken along line XI-XI in FIG. 9. In the present embodiment, the first element group 621 is a piezoelectric element. The first element group 621 has third electrodes 622, piezoelectric materials 623, fourth electrodes 624, and an insulating layer 625. In FIG. 9, the insulating layer 625 is omitted.

The third electrodes 622, the piezoelectric materials 623, and the fourth electrodes 624 are laminated in this order in the -Z direction. The piezoelectric material 623 is provided between the third electrode 622 and the fourth electrode 624 in the Z direction. The third electrode 622 is a lower electrode provided at the +Z direction side of the piezoelectric material 623, that is, at the downside of the piezoelectric material 623. The fourth electrode 624 is an upper electrode provided at the -Z direction side of the piezoelectric material 623, that is, at the upside of the piezoelectric material 623. The third electrode 622 extends in the Y direction, and a plurality of the third electrodes are provided along the X direction. The fourth electrode 624 extends in the X direction, and a plurality of the fourth electrodes are provided along the Y direction. The piezoelectric materials 623 are provided in a matrix in the X direction and the Y direction in portions in which the third electrodes 622 and the fourth electrodes 624 overlap in the Z direction.

The third electrode 622 and the fourth electrode 624 are formed of, for example, a conductive material including a metal such as platinum (Pt), iridium (Ir), gold (Au), or titanium (Ti), or a conductive metal oxide such as indium tin oxide abbreviated as ITO. Alternatively, the third electrode 622 and the fourth electrode 624 may be formed by lamination of a plurality of materials including platinum (Pt), iridium (Ir), gold (Au), and titanium (Ti).

Examples of the piezoelectric material 623 include a so-called perovskite crystal. As the material of the piezoelectric material 623, for example, a ferroelectric piezoelectric material such as lead zirconate titanate (PZT) or a material obtained by adding a metal oxide such as niobium oxide, nickel oxide, or magnesium oxide to the ferroelectric piezoelectric material can be used. Specifically, lead titanate (PbTiO₃), lead zirconate titanate (Pb(Zr,Ti)O₃), lead zirconate titanate (PbZrO₃), lead lanthanum titanate ((Pb,La),TiO₃), lead lanthanum zirconate titanate (Pb,La)(Zr,Ti)O₃), lead magnesium niobate zirconium titanate (Pb(Zr,Ti)(Mg,Nb)O₃), or the like can be used.

The material of the piezoelectric material 623 is not limited to a lead-based piezoelectric material containing lead, but a lead-free piezoelectric material containing no lead may be used. Examples of the lead-free piezoelectric material include bismuth ferrate ((BiFeO₃), abbreviated as "BFO"), barium titanate ((BaTiO₃), abbreviated as "BT"), lithium potassium sodium niobate ((K,Na,Li)(NbO₃)), lithium potassium niobate tantalate ((K,Na,Li)(Nb,Ta)O₃), bismuth potassium titanate ((Bi₁/2K_{1/2})TiO₃, abbreviated as "BKT"), bismuth sodium titanate ((Bi₁/2Na_{1/2})TiO₃, abbreviated as "BNT"), bismuth manganate (BiMnO₃, abbreviated as "BM"), a composite oxide having a perovskite structure containing bismuth, potassium, titanium, and iron (x[(BiₓK₁₋ₓ₎TiO₃]-(1-x)[BiFeO₃), abbreviated as "BKT-BF", a composite oxide having a perovskite structure containing bismuth, iron, barium, and titanium ((1-x)[BiFeO₃]-x[BaTiO₃], abbreviated as "BFO-BT"], and a material obtained by adding a metal such as manganese, cobalt, and chromium thereto ((1-x)[Bi(Fe_{1-y}M_{y})O₃]-x[BaTiO₃] (M is Mn, Co, or Cr).

The first ultrasonic element 626 corresponds to a region where the third electrode 622, the piezoelectric material 623, and the fourth electrode 624 overlap in the Z direction. That is, the first ultrasonic element 626 is an active portion of the piezoelectric element forming the first element group 621. One first ultrasonic element 626 corresponds to one active portion of the piezoelectric element forming the first element group 621. As shown in FIG. 9, the first ultrasonic elements 626 are provided in an array in which the elements are arranged along the X direction and the Y direction. Although FIG. 9 illustrates twelve first ultrasonic elements 626, the first element group 621 preferably has several hundred first ultrasonic elements 626 provided in an array. By applying a voltage between the third electrode 622 and the fourth electrode 624, each first ultrasonic element 626 vibrates in the Z direction, and a first ultrasonic wave having the first frequency is transmitted from each first ultrasonic element 626. The first frequency is a frequency in a range from 1 MHz to 1000 MHz. The first frequency is preferably a frequency within a range from 1 MHz to 10 MHz. In the present embodiment, the first frequency is 5 MHz. In FIGS. 9 to 11, wiring for applying a voltage to the third electrode 622 and the fourth electrode 624 is omitted.

The insulating layer 625 is formed on the upper surface of the piezoelectric elements including the third electrode 622, the piezoelectric materials 623, and the fourth electrodes 624. The insulating layer 625 is formed of, for example, aluminum oxide or zirconium oxide.

In the present embodiment, the second element group 631 is a piezoelectric element. The configuration of the second element group 631 is the same as the configuration of the first element group 621. Therefore, the description of the second element group 631 will be omitted. The second ultrasonic element of the second element group 631 corresponds to the first ultrasonic element 626 of the first element group 621. By applying a voltage to the second element group 631 similarly to the first element group 621, the second ultrasonic element vibrates in the Z direction, and a second ultrasonic wave having the second frequency is transmitted from the second ultrasonic element. The second frequency is lower than the first frequency and is in the range from 1 MHz to 1000 MHz. The second frequency is preferably a frequency within a range from 1 MHz to 10 MHz. In the present embodiment, the second frequency is 1 MHz.

As shown in FIGS. 7 and 8, the first element group 621 and the second element groups 631 are provided to extend along the Y direction as the first direction. The first element groups 621 and the second element groups 631 are alternately arranged along a second direction that is parallel to the injection surface 23 and is orthogonal to the first direction. In the present embodiment, the second direction is the X direction. In the present embodiment, the ultrasonic device 620 includes the one first element group 621 and the two second element groups 631. The first element group 621 and the second element groups 631 are arranged in the order of the second element group 631, the first element group 621, and the second element group 631 in the +X direction. The first element groups 621 and the second element group 631 may be arranged in the order of the first element group 621, the second element group 631, and the first element group 621 in the +X direction. In the state where the cap 610 is attached to the liquid injection head 510, the first element group 621 and the second element groups 631 are disposed on the inner surface 612 of the cap 610 such that the boundaries between the first element group 621 and the second element groups 631 overlap the nozzle rows 25 when viewed from the Z direction. In other words, in the state where the cap 610 covers the injection surface 23, the boundaries between the first element group 621 and the second element groups 631 overlap the nozzle rows 25 when viewed from the direction orthogonal to the injection surface 23. The boundary between the first element group 621 and the second element group 631 is a straight line along the first direction.

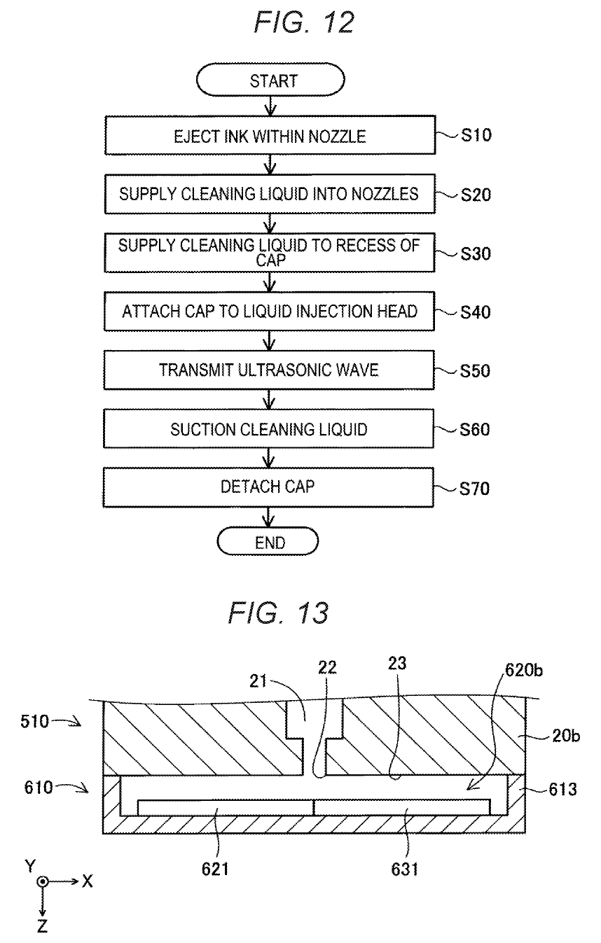

FIG. 12 is a flowchart showing a method of cleaning the nozzles 21. First, in step S10, the ink within the nozzle 21 is ejected.

In step S20, the cleaning liquid is supplied into the nozzle 21. The cleaning liquid is supplied from the cleaning liquid supply device 640 into the nozzle 21 via a pipe (not illustrated). In step S20, the inside of the nozzle 21 is preferably filled with the cleaning liquid.

In step S30, the cleaning liquid is supplied from the cleaning liquid supply device 640 to the recess 611 of the cap 610. The cleaning liquid supply device 640 supplies the cleaning liquid to the recess 611 such that the recess 611 of the cap 610 is filled with the cleaning liquid. Here, it is preferable that the cleaning liquid supplied to the recess 611 is in a convex shape due to surface tension. This is to suppress generation of air bubbles between the cap 610 and the liquid injection head 510 when the cap 610 is attached to the liquid injection head 510.

In step S40, the cap 610 is attached to the liquid injection head 510. The controller 580 controls a cap moving mechanism (not illustrated) for moving the cap 610 to move the cap 610, and attaches the cap 610 to the liquid injection head 510. The cap 610 may be attached to the liquid injection head 510 by moving the liquid injection head 510 with the position of the cap 610 fixed.

In step S50, the controller 580 drives the ultrasonic device 620 to transmit an ultrasonic wave from the ultrasonic device 620. Specifically, the controller 580 drives at least one of the first element group 621 and the second element groups 631. When driving the first element group 621, the controller 580 applies a voltage based on the drive signal to the piezoelectric materials 623 of the first element group 621 to vibrate the first ultrasonic elements 626 and transmit a first ultrasonic wave from the first element group 621. When driving the second element group 631, the controller 580 applies a voltage based on the drive signal to the piezoelectric materials 623 of the second element group 631 to vibrate the second ultrasonic elements and transmit a second ultrasonic wave from the second element group 631. As a result, the nozzle 21 is cleaned by the ultrasonic wave, and the foreign matter adhering to the nozzle 21 is removed.

In the present embodiment, the controller 580 determines which of the first element group 621 and the second element groups 631 to drive according to the type of ink used by the liquid injection head 510 before cleaning the nozzles 21. For example, when the liquid injection head 510 uses UV ink or resin ink, the controller 580 drives the second element groups 631. When the liquid injection head 510 uses aqueous ink, the controller 580 drives the first element group 621. The controller 580 acquires the type of ink used by the liquid injection head 510 from the storage unit before cleaning the nozzles 21. The controller 580 may acquire the type of ink input to the liquid injection apparatus 500 by a user as the type of ink used by the liquid injection head 510 before cleaning the nozzle 21. The type and size of the foreign matter adhering to the nozzle 21 vary depending on the type of ink used by the liquid injection head 510. Therefore, it is possible to efficiently clean the nozzle 21 using an ultrasonic wave having a frequency according to the foreign matter adhering to the nozzle 21.

In step S50, the controller 580 may drive the second element groups 631 after driving the first element group 621, or may drive the first element group 621 after driving the second element groups 631. In this case, since the nozzle 21 can be cleaned using ultrasonic waves having two different frequencies, the performance of removing the foreign matter adhering to the nozzle 21 can be improved.

In step S60, the suction device 650 suctions the cleaning liquid within the recess 611 of the cap 610 and the nozzles 21.

In step S70, the cap 610 is detached from the liquid injection head 510 by the controller 580 controlling the cap moving mechanism. In the above described manner, the cleaning of the nozzles 21 is executed.

In the cleaning of the nozzles 21, the cleaning liquid may be supplied to the inside of the nozzles 21 or the recess 611 of the cap 610 after the cap 610 is attached to the liquid injection head 510. In this case, it is necessary to provide the cap 610 with a member for releasing air, such as a valve for releasing air within the cap 610 to the outside. The head cleaner 600 may include a heating device for heating the cleaning liquid. The heating device may be provided in the cap 610 or may be provided in the cleaning liquid supply device 640.

According to the first embodiment described above, the head cleaner 600 includes the cap 610 that is disposed to face the injection surface 23 and covers the injection surface 23, and the ultrasonic device 620 that is provided in the cap 610 and transmits an ultrasonic wave to the liquid filled in the cap 610. The ultrasonic device 620 includes the first element group 621 in which the plurality of first ultrasonic elements 626 having the resonance frequency of the first frequency and transmitting a first ultrasonic wave having the first frequency are arranged, and the second element group 631 in which the plurality of second ultrasonic elements having the resonance frequency of the second frequency lower than the first frequency and transmitting a second ultrasonic wave having the second frequency are arranged, and the first element group 621 and the second element group 631 are alternately arranged along the second direction parallel to the injection surface 23. Therefore, even when foreign matters having different sizes or a plurality of types of foreign matters adhere to the nozzles 21, it is possible to improve the performance of removing the foreign matters adhering to the nozzles 21.

In the present embodiment, in the state where the cap 610 covers the injection surface 23, the boundary between the first element group 621 and the second element group 631 overlaps the nozzle row 25 when viewed from the direction orthogonal to the injection surface 23. In the present embodiment, since the distance between the first element group 621 and the nozzle row 25 is equal to the distance between the second element group 631 and the nozzle row 25, the first ultrasonic wave and the second ultrasonic wave can be delivered to the nozzles 21 in the same manner.

### B. Second Embodiment:

In a second embodiment, the liquid injection head 510 has one nozzle row 25. In the second embodiment, the configuration of an ultrasonic device 620b is different from that of the first embodiment. The configurations of the respective parts of the liquid injection apparatus 500 except the number of nozzle rows 25 provided in the liquid injection head 510 and the configuration of the ultrasonic device 620b are the same as those in the first embodiment.

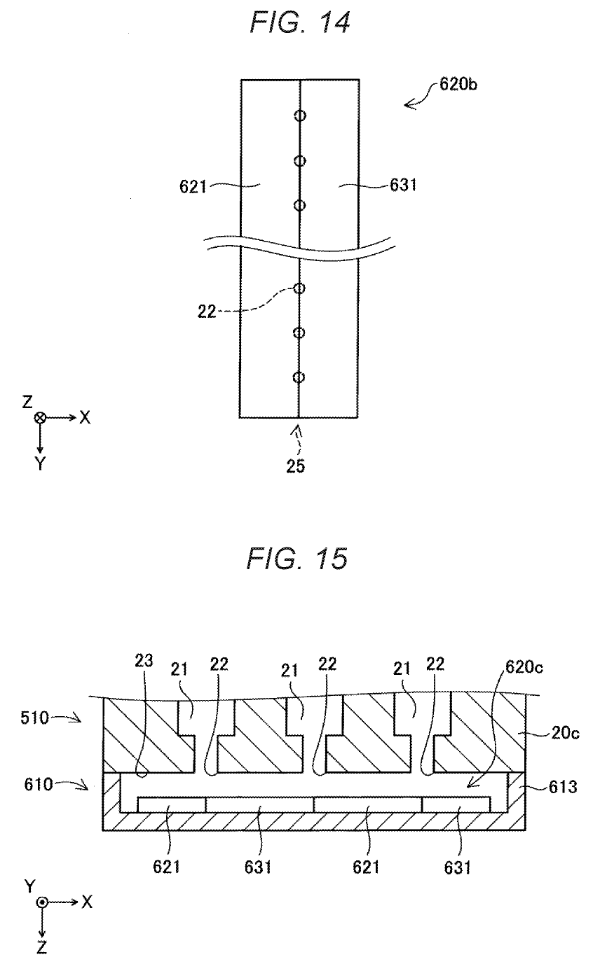

FIG. 13 is a partial cross-sectional view of the liquid injection head 510 and the head cleaner 600 when the cap 610 is attached to the liquid injection head 510 in the second embodiment. FIG. 13 shows a cross-sectional view of a part of a nozzle plate 20b and the head cleaner 600 taken along a plane including the nozzles 21 and being orthogonal to the Y direction as the first direction. FIG. 14 is a top view of the ultrasonic device 620b in the second embodiment.

In the second embodiment, the ultrasonic device 620b includes one first element group 621 and one second element group 631. The first element group 621 and the second element group 631 are arranged in the order of the first element group 621 and the second element group 631 in the +X direction. The first element group 621 and the second element group 631 may be disposed in the order of the second element group 631 and the first element group 621 in the +X direction. In the state where the cap 610 is attached to the liquid injection head 510, the first element group 621 and the second element group 631 are disposed on the inner surface 612 of the cap 610 such that the boundary between the first element group 621 and the second element group 631 overlaps the nozzle row 25 when viewed from the Z direction. In other words, in the state where the cap 610 covers the injection surface 23, the boundary between the first element group 621 and the second element group 631 overlaps the nozzle row 25 when viewed from the direction orthogonal to the injection surface 23. The boundary between the first element group 621 and the second element group 631 is a straight line along the first direction. In the present disclosure, "the first element group 621 and the second element group 631 are alternately disposed along the second direction" includes a case where one first element group 621 and one second element group 631 are disposed side by side along the second direction. That is, in the second embodiment, the first element group 621 and the second element group 631 are alternately arranged along the X direction as the second direction.

According to the second embodiment described above, similarly to the first embodiment, it is possible to improve the performance of removing the foreign matter adhering to the nozzles 21.

### C. Third Embodiment:

In a third embodiment, the liquid injection head 510 has three nozzle rows 25. In the third embodiment, the configuration of an ultrasonic device 620c is different from that of the first embodiment. The configurations of the respective parts of the liquid injection apparatus 500 except the number of nozzle rows 25 provided in the liquid injection head 510 and the configuration of the ultrasonic device 620c are the same as those in the first embodiment.

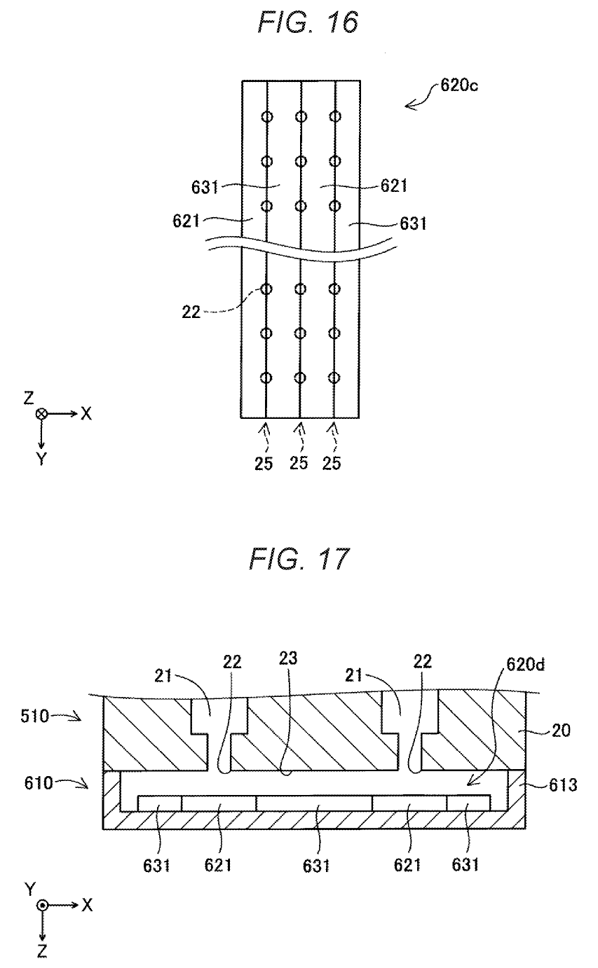

FIG. 15 is a partial cross-sectional view of the liquid injection head 510 and the head cleaner 600 when the cap 610 is attached to the liquid injection head 510 in the third embodiment. FIG. 15 shows a cross-sectional view of a part of a nozzle plate 20c and the head cleaner 600 taken along a plane including the nozzles 21 and being orthogonal to the Y direction as the first direction. FIG. 16 is a top view of the ultrasonic device 620c in the third embodiment.

The first element groups 621 and the second element groups 631 are alternately arranged along the X direction as the second direction. In the third embodiment, the ultrasonic device 620c includes the two first element groups 621 and the two second element groups 631. The first element groups 621 and the second element groups 631 are arranged in the order of the first element group 621, the second element group 631, the first element group 621, and the second element group 631 in the +X direction. The first element groups 621 and the second element groups 631 may be arranged in the order of the second element group 631, the first element group 621, the second element group 631, and the first element group 621 in the +X direction. In the state where the cap 610 is attached to the liquid injection head 510, the first element groups 621 and the second element groups 631 are disposed on the inner surface 612 of the cap 610 such that the boundaries between the first element groups 621 and the second element groups 631 overlap the nozzle rows 25 when viewed from the Z direction. In other words, in the state where the cap 610 covers the injection surface 23, the boundaries between the first element groups 621 and the second element groups 631 overlap the nozzle rows 25 when viewed from the direction orthogonal to the injection surface 23. The boundary between the first element group 621 and the second element group 631 is a straight line along the first direction.

According to the third embodiment described above, similarly to the first embodiment, it is possible to improve the performance of removing the foreign matter adhering to the nozzles 21.

### D. Fourth Embodiment:

In a fourth embodiment, the configuration of an ultrasonic device 620d is different from that of the first embodiment. The configurations of the respective parts of the liquid injection apparatus 500 except the ultrasonic device 620d are the same as those in the first embodiment.

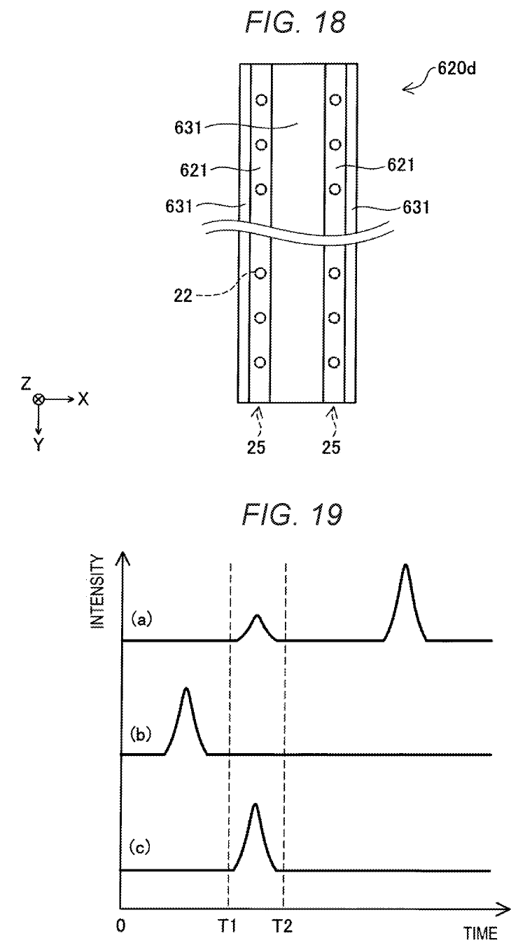

FIG. 17 is a partial cross-sectional view of the liquid injection head 510 and the head cleaner 600 when the cap 610 is attached to the liquid injection head 510 in the fourth embodiment. FIG. 17 shows a cross-sectional view of a part of the nozzle plate 20 and the head cleaner 600 taken along a plane including the nozzles 21 and being orthogonal to the Y direction as the first direction. FIG. 18 is a top view of the ultrasonic device 620d in the fourth embodiment.

The first element groups 621 and the second element groups 631 are alternately arranged along the X direction as the second direction. In the fourth embodiment, the ultrasonic device 620d includes the two first element groups 621 and the three second element groups 631. The first element groups 621 and the second element groups 631 are arranged in the order of the second element group 631, the first element group 621, the second element group 631, the first element group 621, and the second element group 631 in the +X direction. In the state where the cap 610 is attached to the liquid injection head 510, the first element groups 621 are disposed on the inner surface 612 of the cap 610 so as to overlap the nozzle rows 25 when viewed from the Z direction. One first element group 621 is positioned below one nozzle row 25. In the state where the cap 610 is attached to the liquid injection head 510, the second element groups 631 are disposed on the inner surface 612 of the cap 610 so as not to overlap the nozzle rows 25 when viewed from the Z direction. The second element groups 631 are disposed between the two first element groups 621 in the X direction, in the end portion of the ultrasonic device 620d at the +X direction side, and in the end portion of the ultrasonic device 620d at the -X direction side. In other words, in the state where the cap 610 covers the injection surface 23, when viewed from the direction orthogonal to the injection surface 23, the first element groups 621 are disposed in regions overlapping the nozzle rows 25, and the second element groups 631 are disposed in regions not overlapping the nozzle rows 25. The boundary between the first element group 621 and the second element group 631 is a straight line along the first direction.

In the fourth embodiment, the controller 580 drives the first element group 621 in a first drive mode of transmitting a pulsed first ultrasonic wave or a second drive mode of continuously transmitting the first ultrasonic wave. The first drive mode is a mode in which the first element group 621 is used as a distance sensor. The first element group 621 transmits, for example, one pulse wave as the pulsed first ultrasonic wave. The first element group 621 is configured to receive the reflected wave of the pulsed first ultrasonic wave transmitted by the first element group 621. The controller 580 acquires information on the reflected wave of the pulsed first ultrasonic wave from the first element group 621. The controller 580 uses the information acquired from the first element group 621 to calculate a response time, which is the time from when the first element group 621 transmits the pulsed first ultrasonic wave to when the first element group 621 receives the reflected wave of the pulsed first ultrasonic wave. Furthermore, the controller 580 calculates the intensity of the reflected wave of the pulsed first ultrasonic wave received by the first element group 621 using the information acquired from the first element group 621. Hereinafter, the reflected wave of the pulsed first ultrasonic wave transmitted by the first element group 621 is simply referred to as a "reflected wave".

FIG. 19 shows relationships between conditions of the nozzle 21 and waveforms of reflected waves. In FIG. 19, (a) shows an example of the waveform of the reflected wave when no foreign matter is attached to the nozzle 21, (b) shows an example of the waveform of the reflected wave when foreign matter is attached to the vicinity of the nozzle opening 22, and (c) shows an example of the waveform of the reflected wave when foreign matter is attached to the inside of the nozzle 21. The horizontal axis of FIG. 19 indicates an elapsed time from when the first element group 621 transmits the pulsed first ultrasonic wave, and the vertical axis is the intensity of the reflected wave.

As shown by (a), when no foreign matter adheres to the nozzle 21, the first element group 621 receives two reflected waves. The first reflected wave is the first ultrasonic wave reflected by the liquid surface of the ink in the standby state located inside the nozzle 21. The second reflected wave is the first ultrasonic wave reflected by the pressure chamber 12. Hereinafter, the first reflected wave is also referred to as a liquid surface reflected wave, and the second reflected wave is also referred to as a pressure chamber reflected wave. The time from when the first element group 621 transmits the pulsed first ultrasonic wave to when the first element group receives the liquid surface reflected wave is also referred to as a response time of the liquid surface reflected wave, and the time from when the first element group 621 transmits the pulsed first ultrasonic wave to when the first element group receives the pressure chamber reflected wave is also referred to as a response time of the pressure chamber reflected wave. The response time of the pressure chamber reflected wave is longer than the response time of the liquid surface reflected wave.

When foreign matter adheres to the vicinity of the nozzle opening 22, the pulsed first ultrasonic wave transmitted from the first element group 621 is reflected in the vicinity of the nozzle opening 22. Therefore, as shown by (b), the response time when foreign matter adheres to the vicinity of the nozzle opening 22 is shorter than the response time of the liquid surface reflected wave. Examples of the foreign matter adhering to the vicinity of the nozzle opening 22 include fragments of the printing paper P.

When foreign matter adheres to the inside of the nozzle 21, the pulsed first ultrasonic wave transmitted from the first element group 621 is reflected inside the nozzle 21. Therefore, as shown by (c), the response time when foreign matter adheres to the inside of the nozzle 21 is about the same as the response time of the liquid surface reflected wave. Furthermore, the intensity of the reflected wave when foreign matter adheres to the inside of the nozzle 21 is higher than the intensity of the liquid surface reflected wave. Examples of the foreign matter adhering to the inside of the nozzle 21 include solidified ink.

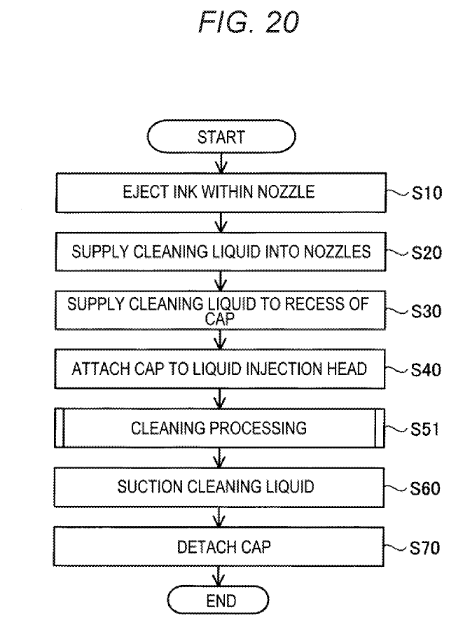

FIG. 20 is a flowchart showing a method of cleaning the nozzles 21 in the fourth embodiment. Note that the same reference numerals are given to portions where the same processing as the cleaning method of the nozzle 21 in the first embodiment is executed, and the description thereof will be omitted.

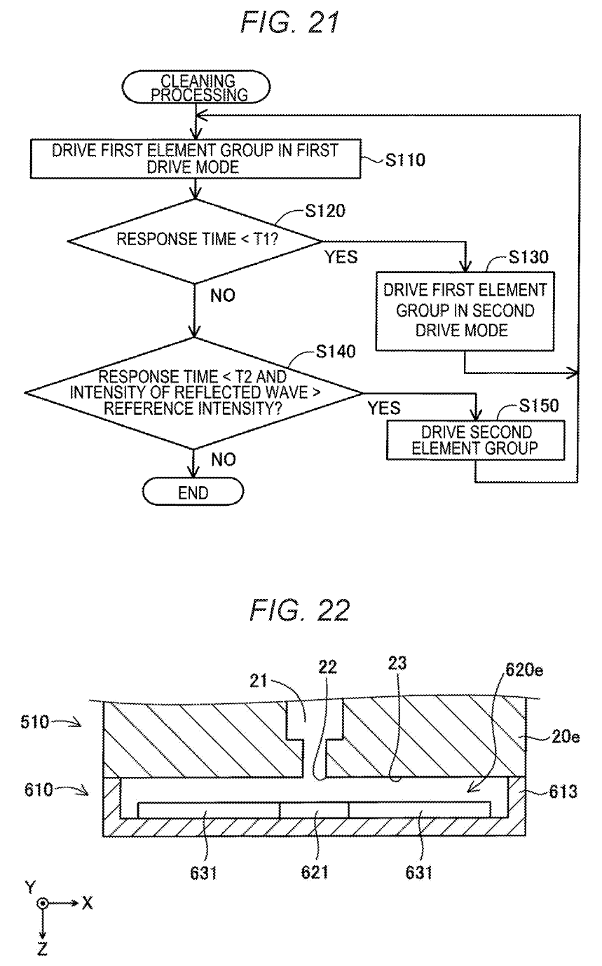

In step S51, cleaning processing is executed. FIG. 21 is a flowchart of the cleaning processing in step S51. In step S110 of the cleaning processing, the controller 580 drives the first element group 621 in the first drive mode to transmit the pulsed first ultrasonic wave from the first element group 621, and calculates the response time of the received reflected wave.

In step S120, the controller 580 determines whether the response time is shorter than a predetermined first time T1. Here, the first time T1 is a time shorter than the response time of the liquid surface reflected wave as illustrated in FIG. 19. The first time T1 is stored in the storage unit in advance. The first time T1 may be set by the user. When the response time is shorter than the first time T1, step S130 is executed. When the response time is equal to or longer than the first time T1, step S140 is executed.

In step S130, the controller 580 drives the first element group 621 in the second drive mode. As described above, when the response time is shorter than the first time T1, it is predicted that foreign matter adheres to the vicinity of the nozzle opening 22. Fragments or the like of the printing paper P are likely to adhere to the vicinity of the nozzle opening 22. In order to remove fragments or the like of the printing paper P, it is preferable to use an ultrasonic wave having a higher frequency. Therefore, the controller 580 drives the first element group 621 having a resonance frequency higher than that of the second element group 631. After step S130 is executed, the processing returns to step S110.

In step S140, the controller 580 determines whether the response time is shorter than a predetermined second time T2 and the intensity of the reflected wave is higher than predetermined reference intensity. Here, the second time T2 is a time longer than the response time of the liquid surface reflected wave as illustrated in FIG. 19. The reference intensity is a value set in advance as intensity at the same degree as the intensity of the liquid surface reflected wave. The second time T2 and the reference intensity are stored in the storage unit in advance. The second time T2 and the reference intensity may be set by the user. When the response time is shorter than the predetermined second time T2 and the intensity of the reflected wave is higher than the predetermined reference intensity, step S150 is executed. When the response time is equal to or longer than the predetermined second time T2 or the intensity of the reflected wave is equal to or lower than the predetermined reference intensity, the cleaning processing is ended. A period between the first time T1 and the second time T2 is also referred to as a reference period.

In step S150, the controller 580 drives the second element group 631. As described above, when the response time is equal to or longer than the first time T1 and shorter than the second time T2, and the intensity of the reflected wave is higher than the reference intensity, it is predicted that foreign matter adheres to the inside of the nozzle 21. The solidified ink or the like is likely to adhere to the inside of the nozzle 21. In order to remove the solidified ink or the like, it is preferable to use an ultrasonic wave having a lower frequency. Therefore, the controller 580 drives the second element group 631 having the resonance frequency lower than that of the first element group 621. After step S150 is executed, the processing returns to step S110. In the above-described manner, the cleaning processing is executed.

According to the fourth embodiment described above, in the state where the cap 610 covers the injection surface 23, when viewed from the direction orthogonal to the injection surface 23, the first element groups 621 are disposed in the regions overlapping the nozzle rows 25, and the second element groups 631 are disposed in the regions not overlapping the nozzle rows 25. Since the first ultrasonic wave has the higher frequency than the second ultrasonic wave, the first ultrasonic wave is easily attenuated in the process of propagating in the liquid. In the present embodiment, since the distance between the nozzle 21 and the first element group 621 is shorter than the distance between the nozzles 21 and the second element group 631, the influence of attenuation of the first ultrasonic wave before reaching the nozzles 21 can be reduced.

In the present embodiment, the controller 580 drives the first element group 621 in the first drive mode in which the pulsed first ultrasonic wave is transmitted or the second drive mode in which the first ultrasonic wave is continuously transmitted. Therefore, it is possible to estimate whether foreign matter adheres to the nozzle 21 and the position of the foreign matter adhering to the nozzle 21 using the first element group 621.

In the present embodiment, the controller 580 drives the first element group 621 in the first drive mode to transmit the pulsed first ultrasonic wave from the first element group 621. The controller 580 drives the first element group 621 in the second mode when the response time is shorter than the predetermined first time T1, and drives the second element group 631 when the response time is equal to or longer than the first time T1 and shorter than the second time T2, which is the predetermined time and longer than the first time T1, and the intensity of the reflected wave is higher than the predetermined reference intensity. The response time and the intensity of the reflected wave change depending on whether the foreign matter is attached to the nozzle 21 and at which position of the nozzle 21 the foreign matter is attached. The position where the foreign matter is likely to adhere to the nozzle 21 varies depending on the type of the foreign matter. Therefore, the foreign matter adhering to the nozzle 21 can be efficiently removed.

### E. Fifth Embodiment:

In a fifth embodiment, the liquid injection head 510 has one nozzle row 25. In the fifth embodiment, the configuration of an ultrasonic device 620e is different from that of the fourth embodiment. The configurations of the respective parts of the liquid injection apparatus 500 except the number of nozzle rows 25 provided in the liquid injection head 510 and the configuration of the ultrasonic device 620e are the same as those in the fourth embodiment. The method of cleaning the nozzles 21 in the fifth embodiment is the same as that in the fourth embodiment.

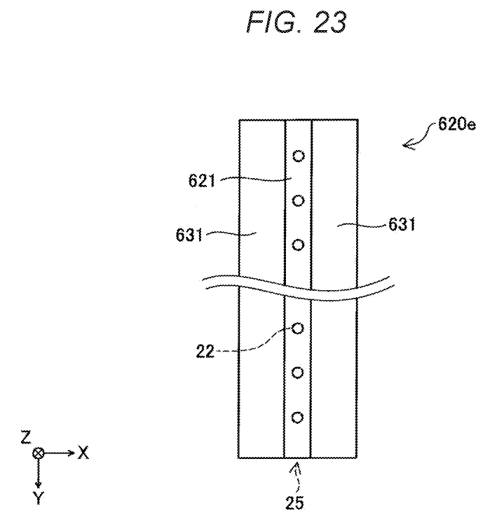

FIG. 22 is a partial cross-sectional view of the liquid injection head 510 and the head cleaner 600 when the cap 610 is attached to the liquid injection head 510 in the fifth embodiment. FIG. 22 shows a cross-sectional view of a part of a nozzle plate 20e and the head cleaner 600 taken along a plane including the nozzles 21 and orthogonal to the Y direction as the first direction. FIG. 23 is a top view of the ultrasonic device 620e in the fifth embodiment.

The first element group 621 and the second element groups 631 are alternately arranged along the X direction as the second direction. In the fifth embodiment, the ultrasonic device 620d includes the one first element group 621 and the two second element groups 631. The first element group 621 and the second element groups 631 are arranged in the order of the second element group 631, the first element group 621, and the second element group 631 in the +X direction. In the state where the cap 610 is attached to the liquid injection head 510, the first element group 621 is disposed on the inner surface 612 of the cap 610 so as to overlap the nozzle row 25 when viewed from the Z direction. One first element group 621 is positioned below one nozzle row 25. In the state where the cap 610 is attached to the liquid injection head 510, the second element groups 631 are disposed on the inner surface 612 of the cap 610 so as not to overlap the nozzle row 25 when viewed from the Z direction. The second element groups 631 are disposed at the +X direction side and the -X direction side of the first element group 621. In other words, in the state where the cap 610 covers the injection surface 23, when viewed from the direction orthogonal to the injection surface 23, the first element group 621 is disposed in a region overlapping the nozzle row 25, and the second element groups 631 are disposed in regions not overlapping the nozzle rows 25. The boundary between the first element group 621 and the second element group 631 is a straight line along the first direction.

According to the fifth embodiment described above, similarly to the fourth embodiment, the influence of attenuation of the first ultrasonic wave before reaching the nozzles 21 can be reduced.

### F. Other Embodiments:

(F-1) In the first to third embodiments, in the state where the cap 610 covers the injection surface 23, the boundary between the first element group 621 and the second element group 631 overlaps the nozzle row 25 when viewed from the direction orthogonal to the injection surface 23. In the first embodiment, the liquid injection head 510 has two nozzle rows 25, in the second embodiment, the liquid injection head 510 has one nozzle row 25, and in the third embodiment, the liquid injection head 510 has three nozzle rows 25. In contrast, the liquid injection head 510 may have four or more nozzle rows 25 in a form in which, in the state where the cap 610 covers the injection surface 23, the boundary between the first element group 621 and the second element group 631 overlaps the nozzle row 25 when viewed from the direction orthogonal to the injection surface 23.

(F-2) In the fourth and fifth embodiments, in the state where the cap 610 covers the injection surface 23, when viewed from the direction orthogonal to the injection surface 23, the first element group 621 is disposed in the region overlapping the nozzle row 25, and the second element group 631 is disposed in the region not overlapping the nozzle row 25. In the fourth embodiment, the liquid injection head 510 has two nozzle rows 25, and in the fifth embodiment, the liquid injection head 510 has one nozzle row 25. In contrast, the liquid injection head 510 may have three or more nozzle rows 25 in a form in which, in the state where the cap 610 covers the injection surface 23, the first element group 621 is disposed in the region overlapping the nozzle row 25 and the second element group 631 is disposed in the region not overlapping the nozzle row 25 when viewed from the direction orthogonal to the injection surface 23.

(F-3) In the fourth embodiment and the fifth embodiment, the controller 580 drives the first element group 621 in the first drive mode or the second drive mode. In contrast, the controller 580 may not drive the first element group 621 in the first drive mode. In this case, the cleaning processing of the nozzle 21 is performed in the same manner as in the first embodiment.

(F-4) In the fourth and fifth embodiments, the controller 580 drives the first element group 621 in the second mode when the response time is shorter than the predetermined first time T1, and drives the second element group 631 when the response time is equal to or longer than the first time T1 and shorter than the second time T2, which is the predetermined time and longer than the first time T1, and the intensity of the reflected wave is higher than the predetermined reference intensity. In contrast, the controller 580 may not drive the first element group 621 in the second mode when the response time is shorter than the predetermined first time T1. Furthermore, the controller 580 may not drive the second element group 631 when the response time is equal to or longer than the first time T1 and shorter than the second time T2, which is the predetermined time and longer than the first time T1, and the intensity of the reflected wave is higher than the predetermined reference intensity.

(F-5) In the embodiment described above, the ultrasonic device 620 is the piezoelectric element. In contrast, the ultrasonic device 620 is not limited to the piezoelectric element as long as the device is capable of generating an ultrasonic wave.

(F-6) In the embodiments described above, the second direction is the direction parallel to the injection surface 23 and orthogonal to the first direction. In contrast, as long as the second direction is a direction parallel to the injection surface 23, the direction may not be orthogonal to the first direction.

### G. Other Configurations:

The present disclosure is not limited to the embodiments described above, and can be implemented in various forms without departing from the scope of the present disclosure. For example, the present disclosure may also be implemented in the following configurations. The technical features in the embodiments described above corresponding to the technical features in the configurations described below can be replaced or combined as appropriate in order to solve a part or all of the problems of the present disclosure, or to achieve a part or all of the effects of the present disclosure. Also, any of the technical features can be deleted as appropriate unless described as essential in the present specification.

(1) According to a first aspect of the present disclosure, a cleaning device is provided. The cleaning device includes a liquid injection head, and a head cleaner disposed below the liquid injection head, wherein the liquid injection head includes a piezoelectric element, a diaphragm that vibrates by driving of the piezoelectric element, a pressure chamber that applies pressure to a liquid stored therein by vibration of the diaphragm, and a nozzle plate having at least one nozzle row in which nozzles communicating with the pressure chamber and injecting the liquid are arranged along a first direction, the nozzle plate has an injection surface in which nozzle openings of the nozzles are formed on a lower surface of the nozzle plate, the head cleaner includes a cap that is disposed to face the injection surface and covers the injection surface, and an ultrasonic device that is provided in the cap and transmits an ultrasonic wave to a liquid filled in the cap, the ultrasonic device includes a first element group in which a plurality of first ultrasonic elements having a first frequency as a resonance frequency and transmitting a first ultrasonic wave having the first frequency are arranged, and a second element group in which a plurality of second ultrasonic elements having a second frequency lower than the first frequency as a resonance frequency and transmitting a second ultrasonic wave having the second frequency are arranged, and the first element group and the second element group are alternately arranged along a second direction parallel to the injection surface.

According to the configuration, even when foreign matters having different sizes or a plurality of types of foreign matters adhere to the nozzles, it is possible to improve the performance of removing the foreign matters adhering to the nozzles.

(2) In the configuration described above, the nozzle plate may include a plurality of the nozzle rows.

(3) In the configuration described above, in a state where the cap covers the injection surface, a boundary between the first element group and the second element group may overlap the nozzle row when viewed from a direction orthogonal to the injection surface.

According to the configuration, since the distance between the first element group and the nozzle row is equal to the distance between the second element group and the nozzle row, the first ultrasonic wave and the second ultrasonic wave can be delivered to the nozzles in the same manner.

(4) In the configuration described above, in a state where the cap covers the injection surface, the first element group may be disposed in a region overlapping the nozzle row and the second element group may be disposed in a region not overlapping the nozzle row when viewed from a direction orthogonal to the injection surface.

Since the first ultrasonic wave has the higher frequency than the second ultrasonic wave, the first ultrasonic wave is easily attenuated in the process of propagating in the liquid. According to the configuration, the influence of attenuation of the first ultrasonic wave before reaching the nozzles can be reduced.

(5) In the configuration described above, a controller that controls the ultrasonic device may be provided, and the controller may drive the first element group in a first drive mode of transmitting the pulsed first ultrasonic wave or a second drive mode of continuously transmitting the first ultrasonic wave.

According to the configuration, it is possible to estimate whether the foreign matter adheres to the nozzle and the position of the foreign matter adhering to the nozzle using the first element group.

(6) In the configuration described above, the controller may drive the first element group in the first drive mode to transmit the pulsed first ultrasonic wave from the first element group, drive the first element group in the second drive mode when a response time from when the first element group transmits the pulsed first ultrasonic wave to when the first element group receives a reflected wave of the pulsed first ultrasonic wave is shorter than a predetermined first time, and drive the second element group when the response time is equal to or longer than the first time and shorter than a second time, which is a predetermined time and longer than the first time, and intensity of the reflected wave is higher than predetermined reference intensity.

The response time and the intensity of the reflected wave change depending on whether the foreign matter is attached to the nozzle and at which position of the nozzle the foreign matter is attached. The position where the foreign matter is likely to adhere to the nozzle varies depending on the type of the foreign matter. According to the configuration, the foreign matter adhering to the nozzle can be efficiently removed.

What is claimed is:

1. A cleaning device comprising:
a liquid injection head; and
a head cleaner disposed below the liquid injection head, wherein
the liquid injection head includes
a piezoelectric element,
a diaphragm that vibrates by driving of the piezoelectric element,
a pressure chamber that applies pressure to a liquid stored therein by vibration of the diaphragm, and
a nozzle plate having at least one nozzle row in which nozzles communicating with the pressure chamber and injecting the liquid are arranged along a first direction,
the nozzle plate has an injection surface in which nozzle openings of the nozzles are formed on a lower surface of the nozzle plate,
the head cleaner includes
a cap that is disposed to face the injection surface and covers the injection surface, and
an ultrasonic device that is provided in the cap and transmits an ultrasonic wave to a liquid filled in the cap,
the ultrasonic device includes
a first element group in which a plurality of first ultrasonic elements having a first frequency as a resonance frequency and transmitting a first ultrasonic wave having the first frequency are arranged, and
a second element group in which a plurality of second ultrasonic elements having a second frequency lower than the first frequency as a resonance frequency and transmitting a second ultrasonic wave having the second frequency are arranged, and
the first element group and the second element group are alternately arranged along a second direction parallel to the injection surface.

2. The cleaning device according to claim 1, wherein
the nozzle plate has a plurality of the nozzle rows.

3. The cleaning device according to claim 1, wherein
in a state where the cap covers the injection surface, a boundary between the first element group and the second element group overlaps the nozzle row when viewed from a direction orthogonal to the injection surface.

4. The cleaning device according to claim 1, wherein
in a state where the cap covers the injection surface, the first element group is disposed in a region overlapping the nozzle row and the second element group is disposed in a region not overlapping the nozzle row when viewed from a direction orthogonal to the injection surface.

5. The cleaning device according to claim 4, further comprising a controller that controls the ultrasonic device, wherein
the controller drives the first element group in a first drive mode to transmit the pulsed first ultrasonic wave or a second drive mode to continuously transmit the first ultrasonic wave.

6. The cleaning device according to claim 5, wherein
the controller drives the first element group in the first drive mode to transmit the pulsed first ultrasonic wave from the first element group, drives the first element group in the second drive mode when a response time from when the first element group transmits the pulsed first ultrasonic wave to when the first element group receives a reflected wave of the pulsed first ultrasonic wave is shorter than a predetermined first time, and drives the second element group when the response time is equal to or longer than the first time and shorter than a second time, which is a predetermined time and longer than the first time, and intensity of the reflected wave is higher than predetermined reference intensity.
